(19) United States
(12) Patent Application Publication
(10) Pub. No.: US 2010/0113632 A1
(43) Pub. Date: May 6, 2010

(54) FLAME RETARDED POLYURETHANE FOAM FORMULATIONS WITH LOW SMOKE PERFORMANCE

(75) Inventors: Rinus Sjerps, Blanden (BE); Eric-Jack Gerard, Gesves (BE); Jan Vijverman, Ninove (BE)

Correspondence Address: ALBEMARLE CORPORATION;PATENT DEPARTMENT, 451 FLORIDA STREET, BATON ROUGE, LA, 70801, US

(73) Assignee: Albermarle Europe SPRL, Louvain-La-Neuve (BE)

(21) Appl. No.: 12/527,637

(22) PCT Filed: Mar. 20, 2008
(86) PCT No.: PCT/EP2008/002295

§ 371 Date: Aug. 18, 2009

(30) Foreign Application Priority Data
Mar. 26, 2007 (US) 60896956
Jun. 14, 2007 (US) 60943934

(51) Int. Cl. C08K 5/51; C09K 21/00

(52) U.S. Cl. 521/107; 252/609

(57) ABSTRACT

The present invention relates to flame retarded polyurethane foam formulations with low smoke performance.

### FIELD OF THE INVENTION

The present invention relates to flame retarded polyurethane foam formulations with low smoke performance.

### BACKGROUND OF THE INVENTION

Polyurethane or polyisocyanurate foams are used in many applications today. Because of their widespread use, much research has been done on providing flame retardancy to polyurethane or polyisocyanurate foams. To this end, halogenated flame retardants and phosphorus flame retardants have been used to provide these flame retardant properties. However, flame retardancy is only one desirable characteristics of polyurethane or polyisocyanurate foams. When polyurethane or polyisocyanurate foams combust, smoke is emitted during the combustion, and it would also be desirable to reduce the emission of this smoke.

### SUMMARY OF THE INVENTION

The present invention relates to a flame retarded polyurethane or polyisocyanurate foam comprising: a) i) at least one, in some embodiments only one, phosphonate, in some embodiments diethyl ethylphosphonate; ii) at least one, in some embodiments only one, isopropylphenyl diphenyl phosphate; iii) at least one, in some embodiments only one, triethyl phosphate; and iv) combinations of i)-iv); b) at least one, in some embodiments only one, bromine-containing flame retardant, in some embodiments a reactive bromine-containing diester/ether diol of tetrabromophthalic anhydride; c) at least one, in some embodiments only one, metal hydroxide; and optionally at least one of: d) at least one dispersing/wetting agent, e) at least one thixotropic additive; and f) at least one, in some embodiments only one, phosphate, in some embodiments a chlorinated phosphate ester, in some embodiments a mono chlorinated phosphate ester. In some embodiments, the flame retarded polyurethane or polyisocyanurate foam comprises d) and e), and component f) is optional. In some embodiments, the flame retarded polyurethane or polyisocyanurate foam comprises d), e), and f).

In another embodiment, the present invention relates to a flame retardant additive suitable for use in polyurethane or polyisocyanurate foam comprising: a) i) at least one, in some embodiments only one, phosphonate, in some embodiments diethyl ethylphosphonate; ii) at least one, in some embodiments only one, isopropylphenyl diphenyl phosphate; iii) at least one, in some embodiments only one, triethyl phosphate; and iv) combinations of i)-iv); b) at least one, in some embodiments only one, bromine-containing flame retardant, in some embodiments a reactive bromine-containing diester/ether diol of tetrabromophthalic anhydride; c) at least one, in some embodiments only one, metal hydroxide; and optionally at least one of: d) at least one dispersing/wetting agent, e) at least one thixotropic additive; and f) at least one, in some embodiments only one, phosphate, in some embodiments a chlorinated phosphate ester, in some embodiments a mono chlorinated phosphate ester. In some embodiments, the flame retardant additive comprises d) and e), and component f) is optional. In some embodiments, the flame retardant additive comprises d), e), and f).

The present invention also relates to a polyurethane or polyisocyanurate foam formulation comprising a) i) at least one, in some embodiments only one, phosphonate, in some embodiments diethyl ethylphosphonate; ii) at least one, in some embodiments only one, isopropylphenyl diphenyl phosphate; iii) at least one, in some embodiments only one, triethyl phosphate; and iv) combinations of i)-iv); b) at least one, in some embodiments only one, bromine-containing flame retardant, in some embodiments a reactive bromine-containing diester/ether diol of tetrabromophthalic anhydride; c) at least one, in some embodiments only one, metal hydroxide; optionally at least one of d), e) and f) wherein d) is at least one dispersing/wetting agent, e) is at least one thixotropic additive, and f) is at least one, in some embodiments only one, phosphate, in some embodiments a chlorinated phosphate ester, in some embodiments a mono chlorinated phosphate ester; g) at least one, in some embodiments only one, isocyanate, polyol, or combination thereof; and h) at least one, in some embodiments only one, blowing agent. Blowing agents suitable for use in the present invention can be readily selected by one having ordinary skill in the art, and typically are selected from water, volatile hydrocarbons, halocarbons, or halohydrocarbons, or mixtures of two or more such materials. In some embodiments, the polyurethane or polyisocyanurate foam formulation comprises d) and e), and component f) is optional. In some embodiments, the polyurethane or polyisocyanurate foam formulation comprises d), e), and f).

The present invention also relates to a polyurethane or polyisocyanurate foam formulation derived from a) i) at least one, in some embodiments only one, phosphonate, in some embodiments diethyl ethylphosphonate; ii) at least one, in some embodiments only one, isopropylphenyl diphenyl phosphate; iii) at least one, in some embodiments only one, triethyl phosphate; and iv) combinations of i)-iv); b) at least one, in some embodiments only one, bromine-containing flame retardant, in some embodiments a reactive bromine-containing diester/ether diol of tetrabromophthalic anhydride; c) at least one, in some embodiments only one, metal hydroxide; optionally at least one of d), e) and f) wherein d) is at least one dispersing/wetting agent, e) is at least one thixotropic additive, and f) is at least one, in some embodiments only one, phosphate, in some embodiments a chlorinated phosphate ester, in some embodiments a mono chlorinated phosphate ester; g) at least one, in some embodiments only one, isocyanate, polyol, or combination thereof; and h) at least one, in some embodiments only one, blowing agent. In some embodiments, d) and e) are used, and component f) is optional. In some embodiments, d), e), and f) are used.

The present invention also relates to a process for forming a flame retarded polyurethane or polyisocyanurate foam comprising combining a) i) at least one, in some embodiments only one, phosphonate, in some embodiments diethyl ethylphosphonate; ii) at least one, in some embodiments only one, isopropylphenyl diphenyl phosphate; iii) at least one, in some embodiments only one, triethyl phosphate; and iv) combinations of i)-iv); b) at least one, in some embodiments only one, bromine-containing flame retardant, in some embodiments a reactive bromine-containing diester/ether diol of tetrabromophthalic anhydride; c) at least one, in some embodiments only one, metal hydroxide; d) at least one dispersing/wetting agents, e) at least one thixotropic additive; and optionally at least one of d), e) and f) wherein d) is at least one dispersing/wetting agent, e) is at least one thixotropic additive; and f) is at least one, in some embodiments only one, phosphate, in some embodiments a chlorinated phosphate ester, in some embodiments a mono chlorinated phosphate ester; g) at least one, in some embodiments only one, isocyanate or polyol; and h) at least one, in some embodiments only one, blowing agent, in the presence of at least one, in some embodiments only one, catalyst. In some embodiments, d) and e) are used, and component f) is optional. In some embodiments, d), e), and f) are used

### DETAILED DESCRIPTION OF THE INVENTION

As stated above, the present invention relates to polyurethane or polyisocyanurate foams, polyurethane or polyisocyanurate foam formulations, and processes for forming flame retarded polyurethane foam formulations, both rigid and flexible. The inventors hereof have discovered that the combination of a) i) at least one, in some embodiments only one, phosphonate, in some embodiments diethyl ethylphosphonate; ii) at least one, in some embodiments only one, isopropylphenyl diphenyl phosphate; iii) at least one, in some embodiments only one, triethyl phosphate; and iv) combinations of i)-iv); b) at least one, in some embodiments only one, bromine-containing flame retardant, in some embodiments a reactive bromine-containing diester/ether diol of tetrabromophthalic anhydride; c) at least one, in some embodiments only one, metal hydroxide; and optionally at least one of: d) at least one dispersing/wetting agents, e) at least one thixotropic additive; and f) at least one, in some embodiments only one, phosphate, in some embodiments a chlorinated phosphate ester, in some embodiments a mono chlorinated phosphate ester, provides for a flame retarded polyurethane or polyisocyanurate foam having low smoke (good smoke reduction properties) and good flame retardancy can be provided. The polyurethanes and polyisocyanurates, the foams thereof, and methods of preparing such polymers are very well known in the art and are reported in the literature. See, for example, Encyclopedia of Polymer Science and Technology, vol. 11, pgs. 506 563 (1969 Wiley & Sons) and vol. 15, pp. 445 479 (1971 Wiley & Sons), U.S. Pat. Nos. 3,974,109; 4,209,609; 4,405,725; 4,468,481; 4,468,482; 5,102,923; 5,164,417; 7,045,564; and 7,153,901; and U.S. patent application Ser. No. 11/569,210, which are all incorporated herein by reference in their entirety.

As stated above, the flame retardant additive of the present invention contains a) i) at least one, in some embodiments only one, phosphonate, in some embodiments diethyl ethylphosphonate; ii) at least one, in some embodiments only one, isopropylphenyl diphenyl phosphate; iii) at least one, in some embodiments only one, triethyl phosphate; and iv) combinations of i)-iv). In some embodiments, the flame retardant additive contains any of i)-iii) alone and in other embodiments, the flame retardant is a combination of i) and ii); i) and iii); i), ii), and iii); or ii) and iii). In some embodiments, when a) is i), or a combination with i), i) is a diethyl ethylphosphonate. The amount of a), sometimes referred to herein as component a), typically present in the flame retardant additive when optional component f) is present in the flame retardant additive, is in the range of from about 2 to about 9 wt. %, preferably in the range of from about 3 to about 7 wt. %, more preferably in the range of from about 4 to about 5 wt. %, all based on the total weight of the flame retardant additive. When optional component f) is not present, the amount of component a) is in the range of from about 0 to about 75% more than the ranges discussed above, i.e. the lower end of the typical range would be in the range of from about 2 to about 4.5 and the upper end of the typical range would be in the range of from about 9 to about 16. Phosphonates suitable for use herein can be selected from any phosphonate known in the art to be effective at providing some flame retardant properties to polyurethane or polyisocyanurate foams, rigid or flexible. Non-limiting examples of suitable phosphonates include diethyl ethylphosphonates, dimethyl methylphosphonates, dimethyl propylphosphonates, the like, etc. Non-limiting examples diethyl ethylphosphonates suitable for use herein can be any known in the art. In preferred embodiments, the diethyl ethylphosphonates are those marketed by the Albemarle® Corporation under the name Antiblaze®, preferably Antiblaze® V490. Isopropylphenyl diphenyl phosphates suitable for use in the present invention can be any known in the art. In preferred embodiments, the isopropylphenyl diphenyl phosphates are those marketed by the Albemarle® Corporation under the name Antiblaze®, preferably the Antiblaze® 500 series, in some embodiments, Antiblaze®519.

Component b) of the flame retardant additive is at least one, in some embodiments only one, bromine-containing flame retardant, in some embodiments reactive bromine-containing diester/ether diol of tetrabromophthalic anhydride. Non-limiting examples of bromine-containing flame retardant suitable for use in the present invention can be any known in the art, such as, for example, Ixol®, Tribromoneopentyl alcohol (“TBNPA”), those marketed by the Albemarle® Corporation under the name Saytex®, and the like. Reactive bromine-containing diester/ether diol of tetrabromophthalic anhydrides suitable for use herein can be any known in the art. In preferred embodiments, the diester/ether diol of tetrabromophthalic anhydrides are those marketed by the Albemarle® Corporation under the name Satyex®, preferably Saytex® RB79, more preferably Saytex® RB7970. The amount of component b) typically present in the flame retardant additive is in the range of from about 16 to about 28 wt. %, preferably in the range of from about 18 to about 26 wt. %, more preferably in the range of from about 20 to about 24 wt. %, all based on the total weight of the flame retardant additive.

Component c) of the flame retardant additive is at least one, in some embodiments only one, metal hydroxide. Metal hydroxides suitable for use herein can be any known in the art having a d50 in the range of from about 1 to about 15, preferably in the range of from about 2 to about 12, more preferably in the range of from about 3 to about 9. The metal hydroxide can be either magnesium hydroxide or aluminum hydroxide, preferably aluminum hydroxide. In preferred embodiments, the metal hydroxides are those marketed by the Albemarle® Corporation under the name Martinal® or Magnifin®, preferably the Martinal® ON series, in some embodiments, Martinal® ON-906. The amount of metal hydroxide typically present in the flame retardant additive is in the range of from about 45 to about 80 wt. %, preferably in the range of from about 50 to about 75 wt. %, more preferably in the range of from about 55 to about 70 wt. %, all based on the total weight of the flame retardant additive.

Component d) of the flame retardant additive is at least one, dispersing/wetting agent. Non-limiting examples of suitable dispersing/wetting agents include solutions of a copolymer with acidic groups. In some embodiments, the dispersing agent is selected from those marketed by BYK Chemie under the BYK® line of products. An example of a product is BYK® W-996. If component d) is present in the flame retardant additive, the amount of component d) typically present is in the range of from about 0.1 to about 3.5 wt. %, preferably in the range of from about 0.25 to about 3 wt. %, more preferably in the range of from about 0.5 to about 2.5 wt. %, based on the total weight of the metal hydroxide.

Optional Component e) of the flame retardant additive is at least one thixotropic additive. Non-limiting examples of suitable thixotropic additives include N-methylpyrrolidone/Litiumchlorode solutions. In some embodiments, the thixotropic additive is selected from those marketed by BYK Chemie under the BYK® line of products. An example of a thixotropic additive suitable for use herein is BYK® W-410. The amount of component e) typically used in the practice of the present invention is in the range of from about 0.1 to about 3.5 wt. %, preferably in the range of from about 0.25 to about 3 wt. %, more preferably in the range of from about 0.5 to about 2.5 wt. %, all based on the total weight of the metal hydroxide.

Optional component f) of the flame retardant additive is at least one, in some embodiments only one, phosphate, in some embodiments a chlorinated phosphate ester, in some embodiments a monochlorinated phosphate ester. In some embodiments, the flame retardant additive includes component f). Phosphates suitable for use herein can be selected from any phosphates known in the art to be effective at providing some flame retardant properties to polyurethane or polyisocyanurate foams, rigid or flexible. Non-limiting examples of suitable phosphates include halogenated phosphate esters, triphenylphosphates, tricresylphosphates, the like, etc. Monochlorinated phosphate esters suitable for use herein can be any known in the art. In some embodiments, the monochlorinated phosphate esters are those marketed by the Albemarle® Corporation under the name Antiblaze®, preferably Antiblaze® TMCP. If component f) is present in the flame retardant additive, the amount of component f) typically present is in the range of from about 7 to about 12 wt. %, preferably in the range of from about 8 to about 9 wt. %, more preferably in the range of from about 9 to about 10 wt. %, all based on the total weight of the flame retardant additive.

The flame retardant additive of this invention can be employed in an effective amount in any known procedure for forming polyurethane or polyisocyanurate foams. Typically, the flame retardant additive will be included as one of various additives employed in the polyurethane or polyisocyanurate foam formation process and will be employed using typical polyurethane or polyisocyanurate foam formation conditions. Further, the polyurethane or polyisocyanurate foams may be used to form articles such as molded and/or extruded foam articles.

By an effective amount of the flame retardant additive, it is meant that amount sufficient to meet or exceed the test standards set forth in DIN 4102 B2 flammability test. Generally, this is in the range of from about 130 to about 180 phr of the flame retardant additive, based on the total weight of the flame retarded polyurethane or polyisocyanurate foam or flame retarded polyurethane or polyisocyanurate foam formulation. In preferred embodiments, an effective amount is to be considered in the range of from about 140 to about 170 phr more preferably in the range of from about 150 to about 160 phr both on the same basis.

The flame retardant additive of the present invention also provides for polyurethane or polyisocyanurate foams having low smoke emissions. By low smoke emissions, it is meant that the polyurethane or polyisocyanurate foam containing an effective amount of the flame retardant additive has a corrected smoke density, as determined by ASTM E662 in non-flaming mode, in the range of from about 70 to about 110, preferably in the range of from about 70 to about 100, more preferably in the range of from about 70 to about 90 and by ASTM E662 in flaming mode in the range of from about 350 to about 600, preferably in the range of from about 350 to about 500, more preferably in the range of from about 350 to about 400, especially for foams with a density of about 35 kg/m³ and sample dimensions of 75×75×30 mm.

In addition to these components the polyurethane or polyisocyanurate foam formulations can contain any other component known in the art and used in the formation for flexible and rigid polyurethane or polyisocyanurate foams, and these other components used in forming polyurethane polymerization formulations or recipes are well known to those of ordinary skill in the art. For example, the polyurethane or polyisocyanurate foam formulations can contain surfactants, antioxidants, diluents such as low viscosity liquid C₁₋₄ halocarbon and/or halohydrocarbon diluents in which the halogen content is 1-4 bromine and/or chlorine atoms can also be included in the compositions of this invention. Non-limiting examples of such diluents include bromochloromethane, methylene chloride, ethylene dichloride, ethylene dibromide, isopropyl chloride, n-butyl bromide, sec-butyl bromide, n-butyl chloride, sec-butyl chloride, chloroform, perchloroethylene, methyl chloroform, and carbon tetrachloride.

It should be noted that these and other ingredients that can be used in the polyurethane or polyisocyanurate foam formulations of the present invention, and the proportions and manner in which they are used are reported in the literature. See for example: Herrington and Hock, Flexible Polyurethane Foams, The Dow Chemical Company, 1991, 9.25 9.27 or Roegler, M “Slabstock Foams”; in Polyurethane Handbook; Oertel, G., Ed.; Hanser Munich, 1985, 176 177 or Woods, G. Flexible Polyurethane Foams, Chemistry and Technology; Applied Science Publishers, London, 1982, 257 260, which is hereby incorporated by reference in its entirety, and U.S. patent application Ser. No. 11/569,210, which has already been incorporated herein by reference.

In the practice of the present invention, the polyurethane or polyisocyanurate foam formulations can be combined with a catalyst, or the individual components combined in the presence of a catalyst, to form a flame retarded polyurethane or polyisocyanurate foam that meets or exceeds the test standards set forth in DIN 4102 B2 flammability test and has a corrected smoke density as discussed above. Catalysts used for producing flexible polyurethane or polyisocyanurate foam include amine catalysts, tin-based catalysts, bismuth-based catalysts or other organometallic catalysts, and the like. Catalysts for rigid polyurethane or polyisocyanurate foams include gel catalysts, blow catalysts, balanced gel/blow catalysts, trimerization catalysts, and the like.

The above description is directed to several embodiments of the present invention. Those skilled in the art will recognize that other means, which are equally effective, could be devised for carrying out the spirit of this invention. It should also be noted that preferred embodiments of the present invention contemplate that all ranges discussed herein include ranges from any lower amount to any higher amount.

The following examples will illustrate the present invention, but are not meant to be limiting in any manner.

### EXAMPLES

In order to determine the smoke suppressant capabilities and flame retardant capabilities of the flame retardant additives of the present invention, four flame retarded rigid foams were manufactured using the formulations described in Table 1, below. Formulation 130106-1 is of this invention and 130106-2 is used as a comparison. All foams were blown with n-pentane as a physical blowing agent and water as a chemical blowing agent, and all foams meet the DIN 4102 B2 test. Dimethylcyclohexylamine (“DMCHA”) was used as a catalyst in forming the foams. As according to the art of making polyurethane foams, we used a surfactant/stabilizer which is a polyether modified polysiloxane. The MDI used was a polymeric MDI.

Also, as used in the following examples, Martinal, Saytex, and Antiblaze are all registered trademarks of the Albemarle Corporation.

TABLE 1

| Ref | Components | pbw | Density |
|---|---|---|---|
| 130106-1 | Polyol Daltolac 535 | 100 | 35 |
| | Saytex RB7970 | 50 | |
| | Antiblaze V490 | 7 | |
| | Martinal ON 310 | 100 | |
| | MDI Index | 115 | |
| 130106-2 | Polyol Daltolac 535 | 100 | 35 |
| | Saytex RB7970 | 108.5 | |
| | MDI Index | 115 | |

Smoke measurements gave the results in Table 2, below

TABLE 2

| | | | | | |
|---|---|---|---|---|---|
| Spezimen | DS max | Time to Ds max(m:s) | Cor. Ds max | dimension | Mass loss (%) |

130106-1
Non-Flamming-Mode

| | | | | | |
|---|---|---|---|---|---|
| 1 | 35 | 02:36 | 34 | 75.37 mm × 75.81 mm × 10.06 mm | 44.9 |
| 2 | 41 | 04:32 | 40 | 75.08 mm × 75.78 mm × 10.06 mm | 47.8 |
| 3 | 37 | 02:19 | 35 | 75.76 mm × 75.18 mm × 10.06 mm | 52.0 |

Flamming-Mode

| | | | | | |
|---|---|---|---|---|---|
| 1 | 125 | 01:21 | 116 | 75.74 mm × 76.23 mm × 10.06 mm | 59.3 |
| 2 | 117 | 01:11 | 111 | 76.14 mm × 75.52 mm × 10.07 mm | 59.2 |
| 3 | 129 | 01:26 | 121 | 76.03 mm × 75.42 mm × 10.06 mm | 58.6 |

130106-2
Non-Flamming-Mode

| | | | | | |
|---|---|---|---|---|---|
| 1 | 62 | 03:44 | 60 | 75.65 mm × 74.99 mm × 10.09 mm | 36.2 |
| 2 | 66 | 03:57 | 63 | 75.15 mm × 76.17 mm × 10.08 mm | 37.6 |
| 3 | 56 | 03:17 | 54 | 75.90 mm × 76.35 mm × 10.09 mm | 42.2 |

Flamming-Mode

| | | | | | |
|---|---|---|---|---|---|
| 1 | 190 | 01:10 | 182 | 75.14 mm × 75.50 mm × 10.08 mm | 82.8 |
| 2 | 157 | 01:08 | 150 | 75.03 mm × 76.00 mm × 10.08 mm | 83.2 |
| 3 | 173 | 01:00 | 167 | 75.07 mm × 75.55 mm × 10.08 mm | 76.7 |

ON-906
Non-Flamming-Mode

| | | | | | |
|---|---|---|---|---|---|
| 1 | 84 | 12:42 | 81 | 75.23 mm × 75.66 mm × 30.79 m | 29.7 |

Flamming-Mode

| | | | | | |
|---|---|---|---|---|---|
| 1 | 428 | 02:59 | 406 | 75.53 mm × 76.33 mm × 30.80 mm | 57.3 |

ON-310
Non-Flamming-Mode

| | | | | | |
|---|---|---|---|---|---|
| 1 | 86 | 09:59 | 84 | 75.54 mm × 74.69 mm × 30.78 mm | 28.6 |

Flamming-Mode

| | | | | | |
|---|---|---|---|---|---|
| 1 | 380 | 02:31 | 363 | 75.23 mm × 75.59 mm × 30.79 mm | 54.6 |

The results in Table 2 show that the corrected smoke density (Cor. Ds max) is significant better (lower) in case of formulation 130106-1 in flaming mode as well in non-flaming mode. The other results show a comparison between Martinal® ON-310 and ON-906. We notice that both products perform similar regarding the corrected smoke density. ON-906 is the preferred mineral flame retardant because of better dispersing behavior in Saytex® RB7970 and Antiblaze® V490 and lower settlement after standing.

1-41. (canceled)

42. A flame retardant additive suitable for use in polyurethane or polyisocyanurate foams comprising:
a) at least one phosphonate;
b) at least one bromine-containing flame retardant;
c) at least one metal hydroxide;
and optionally, at least one of
d) at least one wetting/dispersing agent;
e) at least one thixotropic additive; and
f) at least one, phosphate.

43. The flame retardant additive according to claim 42 wherein:
A) the amount of a) present in the flame retardant additive is in the range of from about 2 to about 9 wt. %, based on the total weight of the flame retardant additives; the amount of h) present in the flame retardant additive is in the range of from about 16 to about 28 wt. %, based on the total weight of the flame retardant additive; the amount of c) present is the flame retardant additive is in the range of from about 45 to about 80 wt. % based on the total weight of the flame retardant additive; or
B) a) is i) at least one diethyl ethylphosphonate; ii) at least one isopropylphenyl diphenyl phosphate; iii) at least one triethyl phosphate; aid iv) combinations; of i)-iv) and a) is present in the flame retardant additive in the range of from about 2 to about 9 wt. %, based on the total weight of the flame retardant additive; or
C) f) is at least one chlorinated phosphate ester and b) is at least one reactive bromine-contained diester/ether diol of tetrabromophthalic anhydride; or
D) a) is a diethyl ethylphosphonate present in the range of from about 2 to about 16 wt. %; b) is a reactive bromine-contained diester/ether diol tetrabromophthalic anhydride present in the range of from about 16 to about 28 wt. %; and c) is present in the range of from 45 to about 80 wt. %, all based on the total weight of the flame retardant additive; or
E) a) is a diethyl ethylphosphonate present in the range of from about 2 to about 9 wt. %; b) is a reactive bromine-contained diester/ether diol of tetrabromophthalic anhydride present in the range of from about lb to about 28 wt. %; c) is present is the range of from about 45 to about 80 wt. %; and f) is present in an amount in the range of from about 7 to about 12 wt. %, all based on the total weight of the flame retardant additive.

44. The flame retardant additive according to claim 43, wherein B) is selected and a) is at least one diethyl ethylphosphonate.

45. The flame retardant additive according to claim 42 therein said flame retardant additive comprises d) and e) or d), e) and f).

46. The flame retardant additive according to claim 45 wherein f) is a monochlorinated phosphate ester.

47. The flame retardant additive according to claim 44 wherein d) and e) are each present in the flame retardant additive in an amount in the range of from about 0.5 to about 2.5 wt. %, based on the total weight of the metal hydroxide.

48. The flame retardant additive according to any of claims 44 or 47 wherein the diethyl ethylphosphonates are those marketed by the Albemarle® Corporation under the name Antiblaze®; the diester/ether dial of tetrabromophthalic anhydrides are those marketed by the Albemarle® Corporation under the name Satyex®; the monochlorinated phosphate esters and brominated flame retardants are those marketed by the Albemarle® Corporation under the name Antiblaze®; the metal hydroxides are marketed by the Albemarle® Corporation under the name Martinal® or Magnifin®; and the wetting/dispersing agents and thixotropic additives are those marketed by BYK Chemie under the name BYK®.

49. The flame retardant additive according to claim 47 wherein f) is present in the flame retardant additive in an amount in the range of from about 7 to about 12 wt. %, based on the total weight of the flame retardant additive.

50. A molded or extruded article mark or produced from the polyurethane or polyisocyanurate foam according to claim 48.

51. A process for forming a flame retarded polyurethane or polyisocyanurate foam comprising combining or bringing together at least one isocyanate or polyol; at least one blowing agent; and a flame retardant additive wherein said, flame retardant additive contains:
a) at least one phosphonate;
b) at least one bromine-containing flame retardant;
c) at least one metal hydroxide;
and optionally, at least one of
d) at least one wetting/dispersing agent;
e) at least one thixotropic additive; and
f) at least one, phosphate;
in the presence of at least one catalyst.

52. The process according to claim 51 wherein a), is i) at least one diethyl ethylphosphonate; ii) at least one isopropylphenyl diphenyl phosphate; iii) at least one triethyl phosphate; or iv) combinations of i)-iv) and a) is present in the flame retardant additive in the range of from about 2 to about 9 wt. %, based on the total weight of the flame retardant additive.

53. The process according to claim 51 wherein a) is at least one diethyl ethylphosphonate and f) is at least one chlorinated phosphate ester.

54. The process according to claim 53 wherein f) is a monochlorinated phosphate ester.

55. The process according to claim 54 wherein the diethyl ethylphosphonate is Antiblaze® V490; the diester/ether dial, of tetrabromophthalic anhydrides is Saytex® RB79 or Saytex® RB7970; the monochlorinated phosphate esters is Antiblaze® TMCP; and the metal hydroxides are those marketed, by the Albemarle® Corporation under the Martinal® ON series; and the wetting/dispersing agents and thixotropic additives are those marketed by BYK Chemie under the name BYK®.

56. The process according to claim 51 wherein the flame retarded polyurethane or polyisocyanurate foam thus produced meets or exceeds the test standards set forth in DIM 4102 B2 flammability test and has a corrected smoke density, as determined by ASTM E662 in non-flaming mode, in the range of from about 70 to about 110.

57. The flame retarded polyurethane or polyisocyanurate foam formed by the process according to claim 51.
